(19) United States
(12) Patent Application Publication
(10) Pub. No.: US 2018/0089725 A1
(43) Pub. Date: Mar. 29, 2018

(54) PRODUCT INFORMATION MANAGEMENT APPARATUS, PRODUCT INFORMATION MANAGEMENT SYSTEM, PRODUCT INFORMATION MANAGEMENT METHOD, AND PROGRAM

(71) Applicant: NEC CORPORATION, Tokyo (JP)

(72) Inventors: Eiji MURAMATSU, Tokyo (JP); Jun KOBAYASHI, Tokyo (JP); Shinichi ANAMI, Tokyo (JP)

(73) Assignee: NEC CORPORATION, Tokyo (JP)

(21) Appl. No.: 15/559,990

(22) PCT Filed: Mar. 18, 2016
(86) PCT No.: PCT/JP2016/058662

§ 371 Date: Sep. 20, 2017

(30) Foreign Application Priority Data
Mar. 23, 2015 (JP) 2015-059496

(51) Int. Cl. G06Q 30/02; G06Q 30/06; G06K 9/00

(52) U.S. Cl. CPC G06Q 30/0282; G06K 9/00221; G06Q 30/06; G06Q 30/0269

(57) ABSTRACT

A product information management apparatus includes a product specifying unit that specifies a product that was approached by a user in an actual store; an association unit that generates association information, which is information associating the product specified by the product specifying unit with the user or related information relating to the information associating the product with the user; and a recording unit that records the association information in a memory unit so as to be able to be viewed by the user.

### TECHNICAL FIELD

The present invention relates to a product information management apparatus, a product information management system, a product information management method, and a program.

### BACKGROUND ART

A user of an actual store (brick-and-mortar shop) may sometimes touch and have interest in a product in the actual store, but may leave the actual store without purchasing the product due to certain circumstances. Examples of cases in which products are not purchased include cases in which the user is considering purchasing the product in another store (including actual stores and virtual stores (online shops)), cases in which funds are insufficient, and cases in which the product is inconvenient to carry home.

Patent Document 1 discloses analyzing the actions of multiple customers and calculating the level of attention given to products placed on merchandise shelves, and outputting advertisements for products in which the level of attention is high.

### PRIOR ART DOCUMENT

### Patent Document

Patent Document 1: Japanese Unexamined Patent Application, First Publication No. 2014-56356

### SUMMARY OF THE INVENTION

### Problems to be Solved by Invention

A user of an actual store, after leaving the actual store, may sometimes forget about a product in which the user was interested while in the actual store. In such cases, the user will not be able to later purchase the product in which the user was interested but was not able to purchase due to certain circumstances. According to the invention described in Patent Document 1, information about a product in which multiple customers expressed interest is outputted as an advertisement. However, the product is merely a product in which multiple customers expressed interest, and will not necessarily be a product in which the customer viewing the advertisement is interested.

An exemplary object of the present invention is to provide a product information management apparatus, a product information management system, a product information management method, and a program capable of solving the above-mentioned problems.

### Means for Solving the Problems

According to a first exemplary aspect of the present invention, a product information management apparatus includes a product specifying unit that specifies a product that was approached by a user in an actual store; an association unit that generates association information, which is information associating the product specified by the product specifying unit with the user or related information relating to the information associating the product with the user; and a recording unit that records the association information in a memory unit so as to be able to be viewed by the user.

According to a second exemplary aspect of the present invention, a product information management system includes the product information management apparatus according to the above-mentioned aspect; and the memory unit that stores the association information.

According to a third exemplary aspect of the present invention, a product information management method includes a step of specifying a product that was approached by a user in an actual store; a step of generating association information, which is information associating the specified product with the user or related information relating to the information associating the product with the user; and a recording step of recording the association information in a memory unit so as to be able to be viewed by the user.

According to a fourth exemplary aspect of the present invention, a program causes a computer to function as: a product specifying unit that specifies a product that was approached by a user in an actual store; an association unit that generates association information, which is information associating the product specified by the product specifying unit with the user or related information relating to the information associating the product with the user; and a recording unit that records the association information in a memory unit so as to be able to be viewed by the user.

### Advantageous Effects of the Invention

According to at least one of the above-mentioned exemplary aspects, by viewing information recorded in a memory unit, a user can recognize products that the user approached in actual stores. Therefore, it is possible to keep the user from forgetting about products that were approached in actual stores.

### BRIEF DESCRIPTION OF THE DRAWINGS

FIG. 1 is a schematic diagram showing the structure of a product information management system according to a first exemplary embodiment.

FIG. 2A is a diagram showing an example of information stored by a database apparatus.

FIG. 2B is a diagram showing an example of information stored by a database apparatus.

FIG. 2C is a diagram showing an example of information stored by a database apparatus.

FIG. 3 is a schematic block diagram showing the structure of a product information management server according to the first exemplary embodiment.

FIG. 4 is a flow chart showing product registration operations performed by the product information management server according to the first exemplary embodiment.

FIG. 5 is a flow chart showing purchase operations performed by the product information management server according to the first exemplary embodiment.

FIG. 6 is a flow chart showing cart presentation operations performed by the product information management server according to the first exemplary embodiment.

FIG. 7 is a schematic diagram showing the structure of a product information management system according to a second exemplary embodiment.

FIG. 8 is a schematic block diagram showing the structure of a product information management server according to the second exemplary embodiment.

FIG. 9 is a flow chart showing user identification information extraction operations performed by the product information management server according to the second exemplary embodiment.

FIG. 10 is a schematic diagram showing the structure of a product information management system according to a third exemplary embodiment.

FIG. 11 is a schematic block diagram showing the structure of a product information management server according to the third exemplary embodiment.

FIG. 12 is a flow chart showing user identification information extraction operations performed by the product information management server according to the third exemplary embodiment.

FIG. 13 is a flow chart showing product registration operations performed by the product information management server according to the third exemplary embodiment.

FIG. 14 is a schematic block diagram showing the structure of a product information management server according to a fourth exemplary embodiment.

FIG. 15 is a schematic block diagram showing the basic structure of a product information management apparatus.

FIG. 16 is a schematic block diagram showing the structure of a computer according to at least one of the exemplary embodiments.

### MODES FOR CARRYING OUT THE INVENTION

### First Exemplary Embodiment

Herebelow, a first exemplary embodiment will be explained in detail with reference to the drawings.

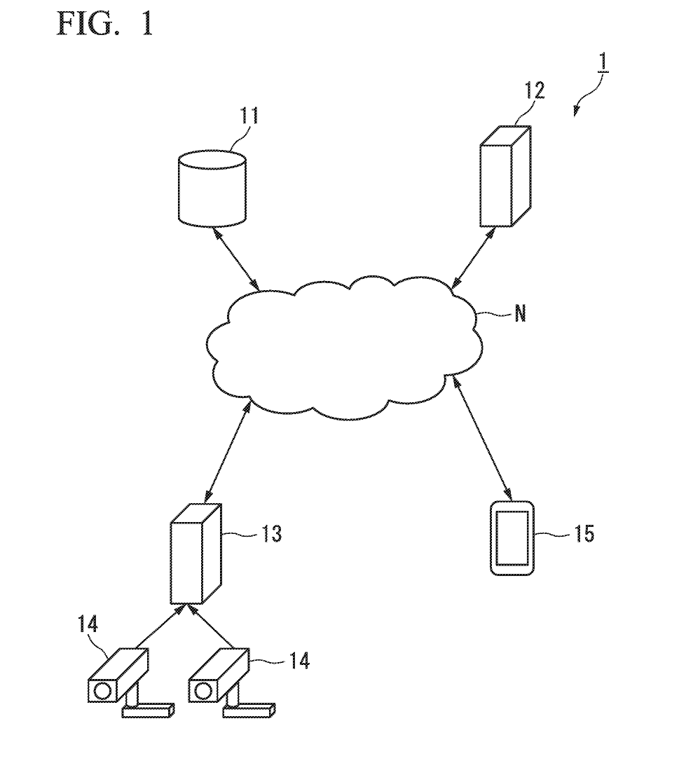

FIG. 1 is a schematic diagram showing the structure of a product information management system according to the first exemplary embodiment.

The product information management system 1 presents, to a pre-registered user, a product that was approached by the user in an actual store (brick-and-mortar shop) but was not purchased. In this case, the product that was approached by the user is a product to which the user came close, or which captured the attention of the user. In other words, the term “approach” as used in the present description is not limited to physical approaches, and includes psychological approaches due to a user having interest drawn to the product. Additionally, the “product” described in the present description refers to goods and services that can be the object of a transaction, and is not necessarily required to be tangible, to require payment, or to be commercially available. For example, free samples, real estate, and rental services are all included as “products”. Additionally, the term “product” as used in the present description includes samples of the product that are exhibited for the purpose of transfer of the product and advertisements for the product.

Specifically, the product information management system 1 provides the user with a shopping cart service, and registers, in a virtual cart, a product that was approached in an actual store but not purchased, as a purchase candidate product in an affiliated virtual store (online shop).

It is to be noted that the term “actual store” in the present description refers to a location at which products are actually arranged and sold. Moreover, the term “virtual store” in the present description refers to a webpage over which procedures for purchasing a product can be performed via the internet. Additionally, the term “virtual cart” in the present description refers to a memory area in which products to be purchased are temporarily stored.

The product information management system 1 includes a database apparatus 11, a product information management server 12, a store server 13, imaging apparatuses 14, and a user terminal 15. The database apparatus 11, the product information management server 12, the store server 13, and the user terminal 15 are connected with each other via a network N.

The database apparatus 11 stores a user table containing user information, a product table containing product information, and a cart table containing purchase candidate products for each user. The information contained in the cart table is converted to display information by the product information management server 12 and displayed on the user terminal 15. In other words, the cart table in the database apparatus 11 is an example of a memory unit that can be viewed by a user.

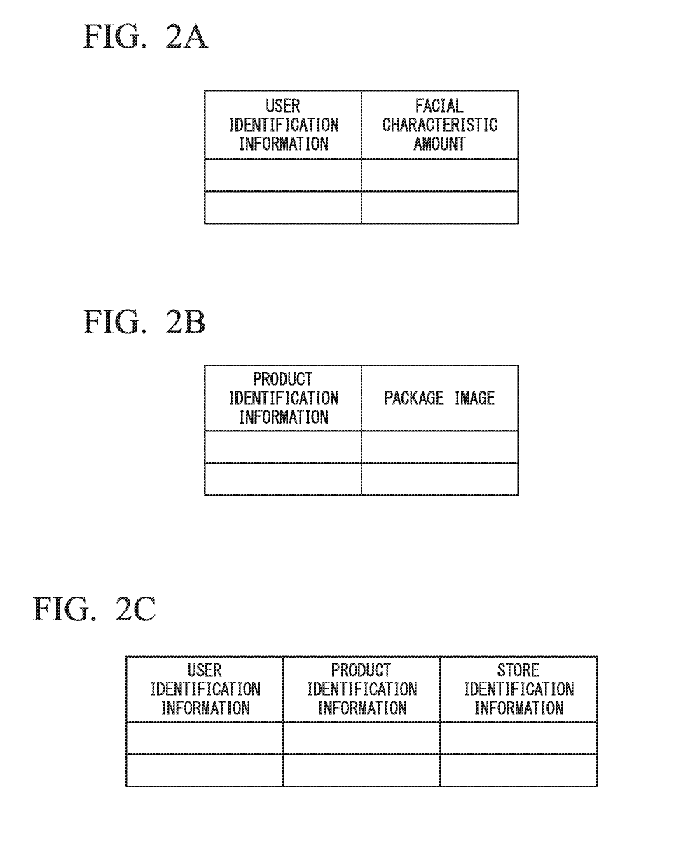

FIGS. 2A-2C are diagrams showing examples of information stored by the database apparatus.

FIG. 2A is a diagram showing an example of a user table.

As shown in FIG. 2A, the user table contains, in association with each other, user identification information and facial characteristic amounts. An example of user identification information is account information for a shopping cart service. A facial characteristic amount is an example of user characteristic information for specifying a user. The facial characteristic amount is information that is pre-acquired by analyzing image information in which the user appears when registering the user. It is to be noted that in the present exemplary embodiment, a facial characteristic amount is used as the user characteristic information, but the present exemplary embodiment is not limited thereto. For example, in other exemplary embodiments, facial images, action characteristic amounts (such as ambulatory patterns), or other user characteristic information may be used.

FIG. 2B is a diagram showing an example of a product table.

The product table contains, in association with each other, product identification information and package images. An example of product identification information includes a JAN (Japanese Article Number) code that is represented by a bar code applied to the product package. A package image is an example of product characteristic information for specifying the product.

FIG. 2C is a diagram showing an example of a cart table.

The cart table contains, in association with each other, user identification information, product identification information, and store identification information for the actual store in which the product was approached. In other words, the cart table contains virtual cart information for each user.

The product information management server 12 provides a shopping cart service to users by using the information stored in the database apparatus 11. Specifically, the product information management server 12 acquires, from the store server 13, image information that was captured in an actual store, and stores, in the database apparatus 11, information on a product that was approached by the user. Additionally, the product information management server 12 presents, to the user terminal 15, information on products associated with the user possessing the user terminal 15.

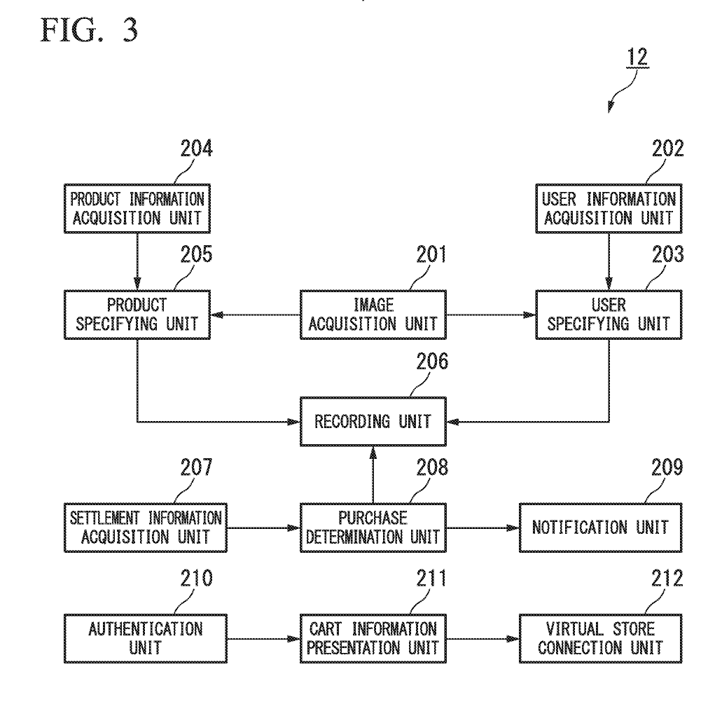

FIG. 3 is a schematic block diagram showing the structure of a product information management server according to the first exemplary embodiment.

The product information management server 12 includes an image acquisition unit 201, a user information acquisition unit 202, a user specifying unit 203, a product information acquisition unit 204, a product specifying unit 205, a recording unit 206, a settlement information acquisition unit 207, a purchase determination unit 208, a notification unit 209, an authentication unit 210, a cart information presentation unit 211, and a virtual store connection unit 212.

The image acquisition unit 201 acquires image information from the store server 13.

The user information acquisition unit 202 acquires user identification information and a facial characteristic amount from the user table stored in the database apparatus 11.

The user specifying unit 203 specifies a user appearing in an image indicated by the image information acquired by the image acquisition unit 201 on the basis of information acquired by the user information acquisition unit 202.

The product information acquisition unit 204 acquires product identification information and a package image from the product table stored in the database apparatus 11.

The product specifying unit 205 specifies a product that was approached by the user specified by the user specifying unit 203 on the basis of the information acquired by the product information acquisition unit 204.

The recording unit 206 records, in a cart table in the database apparatus 11, the user specified by the user specifying unit 203 and the product specified by the product specifying unit 205, in association with each other.

The settlement information acquisition unit 207 acquires info′ nation pertaining to settlement of the product from the store server 13. Specifically, the settlement information acquisition unit 207 acquires product identification information for a settled product and user identification information for the user who purchased the product.

The purchase determination unit 208 determines whether or not a product recorded in the cart table has been purchased, by a user associated with the product, at the actual store associated with the product and the user. The purchase determination unit 208 determines whether or not a product recorded in the cart table has been purchased, by the user associated with the product, at a store other than the actual store associated with the product and the user. In other words, the purchase determination unit 208 is an example of an in-store purchase determination unit and an out-of-store purchase determination unit.

The notification unit 209 notifies the store server 13 of the actual store associated with a product recorded in the cart table that the product has been purchased in a store other than the actual store associated with the product.

The authentication unit 210 acquires user identification information from the user terminal 15 and authenticates the user.

The cart information presentation unit 211 acquires virtual cart registration information of the user authenticated by the authentication unit 210 from the cart table stored in the database apparatus 11, and outputs the information to the user terminal 15.

The virtual store connection unit 212 connects the user terminal 15 to a virtual store that sells the product registered in the virtual cart.

The store server 13 transmits, to the product information management server 12, image information of a moving image captured by an imaging apparatus 14 provided in the actual store. The store server 13 is provided in each actual store that is affiliated with the shopping cart service.

The imaging apparatus 14 is provided on the sales floor of each actual store affiliated with the shopping cart service, and captures moving images of the sales floor. The imaging apparatus 14 is installed so that products and users appear in the moving images that are captured. The imaging apparatus 14 is an example of a sensing device provided in an actual store. The images captured by the imaging apparatus 14 are outputted to the store server 13 provided in the same actual store as the imaging apparatus 14.

The user terminal 15 is a communication terminal possessed by the user. By executing a predetermined application program, the user terminal 15 receives, from the product information management server, product information that is registered to a virtual cart associated with the user.

With the above-described structure, the product information management server 12 registers, in the virtual cart, a user and a product that was approached by the user, in association with each other. As a result thereof, by viewing information registered in the virtual cart by the user terminal 15, the user can be prevented from forgetting a product in which the user was interested but was not able to purchase in an actual store due to certain circumstances.

The operations of the product information management server according to the present exemplary embodiment will be explained.

First, the operations whereby the product information management server 12 writes records into the cart table in the database apparatus 11 will be explained.

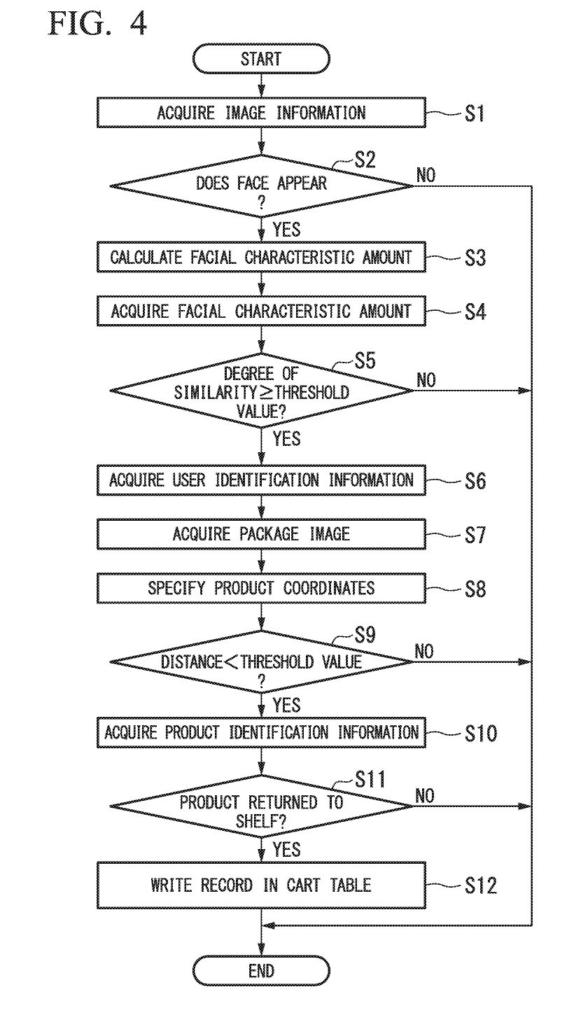

FIG. 4 is a flow chart showing the product registration operations by the product information management server according to the first exemplary embodiment.

The image acquisition unit 201 in the product information management server 12 acquires image information from the store server 13 (step S1). The image information shows a frame image from a moving image captured by the imaging apparatus 14. Next, the user specifying unit 203 executes a predetermined facial recognition process on the acquired image information and determines whether or not a face appears in the image indicated by the image information (step S2). If a face does not appear in the image indicated by the image information (step S2: NO), the product information management server 12 ends the process.

In contrast, if a face does appear in the image indicated by the image information (step S2: YES), the user specifying unit 203 analyzes the area of the image information in which the face appears, and calculates a facial characteristic amount (step S3). Next, the user information acquisition unit 202 acquires the facial characteristic amounts of all users from the user table in the database apparatus 11 (step S4). Next, the user specifying unit 203 determines whether or not the degree of similarity between the facial characteristic amount specified in step S3 and a facial characteristic amount acquired by the user information acquisition unit 202 is equal to or greater than a predetermined threshold value (step S5). If the degree of similarity between the facial characteristic amounts is less than the predetermined threshold value for the degree of similarity (step S5: NO), in other words, if the face appearing in the image information is not similar to any of the registered users, the product information management server 12 ends the process.

If the degree of similarity between the facial characteristic amounts is equal to or greater than the predetermined threshold value for the degree of similarity (step S5: YES), then the user information acquisition unit 202 acquires user identification information associated with the facial characteristic amount from the user table in the database apparatus 11 (step S6). As a result thereof, the user specifying unit 203 specifies the user appearing in the image indicated by the image information.

Next, the product information acquisition unit 204 acquires package images for all products from the product table in the database apparatus 11 (step S7). Next, the product specifying unit 205 performs pattern-matching between the acquired image information and the package images, and specifies the coordinates of products appearing in the image indicated by the image information (step S8). Next, from the coordinates specified in step S8, the product specifying unit 205 determines whether or not there are any coordinates for which the distance from a central coordinate of an area in which the face appears in the image information is less than a predetermined distance threshold value (step S9). If there are no coordinates for which the distance from the central coordinate of the area in which the face appears is less than the distance threshold value (step S9: NO), the product information management server 12 ends the process. This is because it is inferred that the user has not approached any specific products.

If there are coordinates for which the distance from the central coordinate of the area in which the face appears is less than the distance threshold value (step S9: YES), the product information acquisition unit 204 acquires, from the product table in the database apparatus 11, product identification information associated with the package image matched to the specified coordinates (step S10). As a result thereof, the product specifying unit 205 specifies a product that was approached by the user.

Next, the product specifying unit 205 determines, on the basis of a frame image acquired by the image acquisition unit 201, whether or not the product was returned to the display shelf after the user approached the product (step S11). Methods for determining whether or not the product was returned to the display shelf may, for example, be based on whether or not the distance between the coordinates of the product and the coordinates of the display shelf is equal to or less than a predetermined threshold value, or on whether or not the degree of similarity between a user action characteristic amount and a standard return action characteristic amount is equal to or greater than a predetermined threshold value. If the product is not returned to the display shelf (step S11: NO), the process is ended without recording the user and the product in the cart table in the database apparatus 11. This is because while the products that should be registered in the virtual cart are products in which interest was expressed in the actual store but were not purchased due to certain circumstances, products that were not returned to a display shelf are very likely to be purchased.

When a product is returned to the display shelf (step S11: YES), the recording unit 206 writes, into the cart table in the database apparatus 11, a record associating user identification information specified by the user specifying unit 203, product identification information specified by the product specifying unit 205, and store identification information for the actual store provided with the store server 13 that transmitted the image information (step S12). In other words, the recording unit 206 generates association information associating user identification information specified by the user specifying unit 203, product identification information specified by the product specifying unit 205, and store identification information for the actual store provided with the store server 13 that transmitted the image information, and records the association information in the database apparatus 11. In other words, the recording unit 206 is an example of an association unit.

As a result of the above processes, the product information management server 12 is able to register, in a virtual cart, a user, a product that was approached by the user, and an actual store in which the product was exhibited, in association with each other.

Next, the operations of the product information management server 12 when a user purchases a product will be explained.

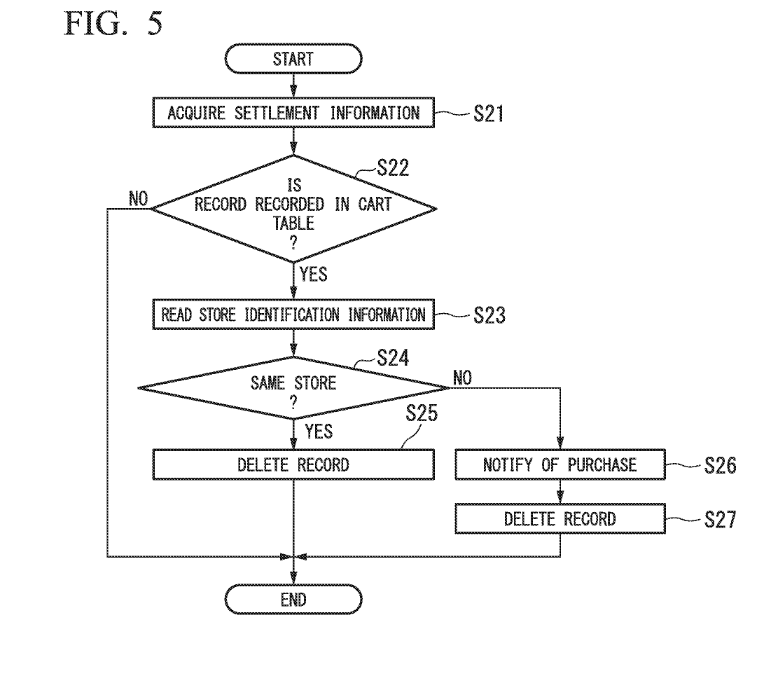

FIG. 5 is a flow chart showing purchase operations performed by a product information management server according to the first exemplary embodiment.

When a product is purchased in a store (actual store or virtual store), a store server 13 of the store in which the product was purchased transmits settlement information to the product information management server 12. The settlement information includes product identification information for the purchased product and user identification information for the user who purchased the product. The store server 13 can acquire the settlement information, for example, from a POS (Point of service) terminal. The settlement information acquisition unit 207 in the product information management server 12 acquires settlement information from the store server 13 (step S21). Next, the purchase determination unit 208 determines whether or not a record including the combination of the product identification information and the user identification information contained in the settlement information is recorded in the cart table in the database apparatus 11 (step S22).

If a record including the combination of the product identification information and the user identification information contained in the settlement information is not recorded in the cart table (step S22: NO), then the product information management server 12 ends the process. In contrast, if a record including the combination of the product identification information and the user identification information contained in the settlement information is recorded in the cart table (step S22: YES), the purchase determination unit 208 reads out the store identification information contained in the record (step S23).

Next, the purchase determination unit 208 determines whether or not the parent business of the store indicated by the store identification information that has been read out is the same as the parent business of the store in which the store server 13 that transmitted the settlement information is installed (step S24). If the parent business of the store indicated by the store identification information is the same as the parent business of the store in which the store server 13 is installed (step S24: YES), the recording unit 206 deletes the record specified in step S22 (step S25). As a result thereof, the product information management server 12 is able to delete information on products that have already been purchased by a user from the virtual cart of the user.

In contrast, if the parent business of the store indicated by the store identification information is different from the parent business of the store in which the store server 13 is installed (step S24: NO), the notification unit 209 outputs, to the store server 13 of the store indicated by the store identification information read out in step S23, a notification to the effect that the product has been purchased at another store (step S26). The notification includes store identification information for the store in which the store server 13 that transmitted the settlement information acquired in step S21 is installed, and the product identification information and the user identification information contained in the record specified in step S22. As a result thereof, even if the product was not purchased at the actual store that is recorded in the cart table, in other words, the actual store in which the user encountered the product, the store can still obtain a commission (affiliate fee) from the store at which the product was actually purchased.

It is to be noted that since the cost of operating a virtual store is lower than that of an actual store, the price of a product may be lower than that in an actual store. For this reason, it was not uncommon for the sales of actual stores to be reduced due to showrooming, in which a user inspects a product in an actual store and then purchases the product at a virtual store. In contrast thereto, according to the product information management server 12 of the present exemplary embodiment, the actual store in which the user encountered a product can obtain a fee from the store at which the product was actually purchased, so the actual store can suppress decreases in sales due to showrooming. When the notification unit 209 outputs the notification in step S26, the recording unit 206 deletes the record specified in step S22 (step S27). As a result thereof, the product information management server 12 is able to delete information on products that have already been purchased by a user from the virtual cart of the user.

Thus, by executing the above-described procedure, the product information management server 12 can delete, from the cart table, records for products that have already been purchased. As a result thereof, the product information management server 12 can write records in a manner distinguishing between whether or not a product has been purchased.

Next, the operations of the product information management server 12 when accessed by a user terminal 15 will be explained.

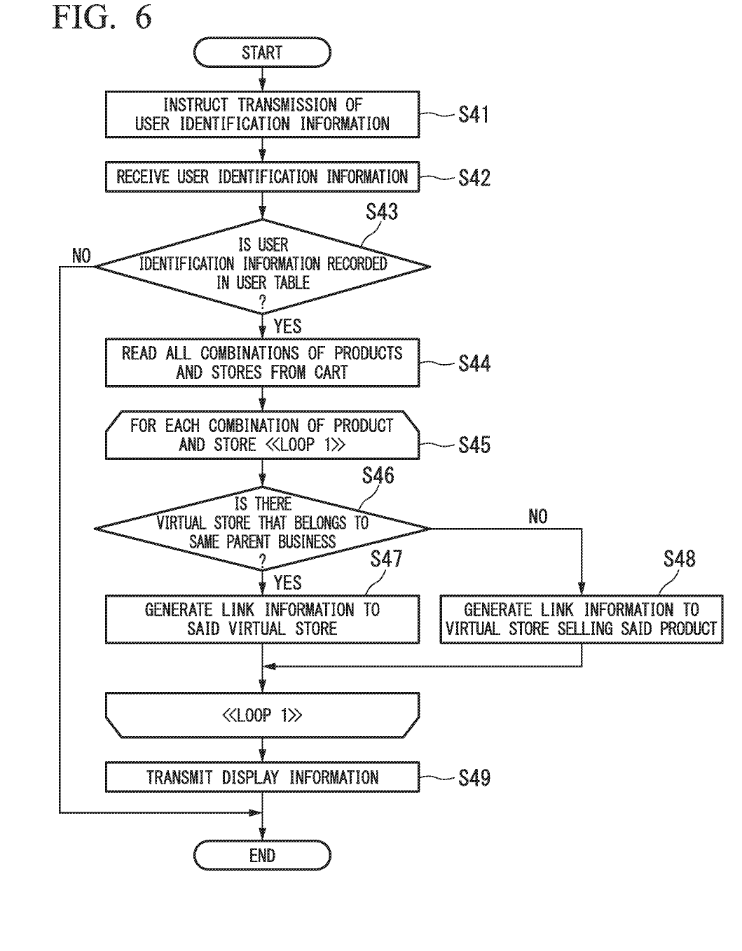

FIG. 6 is a flow chart showing cart presentation operations performed by the product information management server according to the first exemplary embodiment.

When the product information management server 12 is accessed by a predetermined application program from a user terminal 15 operated by a user, the authentication unit 210 of the product information management server 12 instructs the user terminal 15 to transmit user identification info′ nation (step S41). The user terminal 15 transmits user identification information inputted by a user to the product information management server 12. It is to be noted that the user identification information may be recorded in a setup file based on an input from the user during initial activation of the application program.

The authentication unit 210, upon receiving the user identification information from the user terminal 15 (step S42), determines whether or not the user identification information is recorded in the user table of the database apparatus 11 (step S43). If the user identification information is not recorded in the user table (step S43: NO), the authentication unit 210 outputs a notification indicating that the authentication failed to the user terminal 15, and the process ends. In contrast, if the user identification information is recorded in the user table (step S43: YES), the cart information presentation unit 211 reads out all of the product identification information and the store identification information that is associated with said user identification information in the cart table (step S44).

Next, the product information management server 12 selects, one by one, combinations of the product identification information and store identification information that have been read out, and for each combination, executes the processes in steps S46 to step S48 indicated below (step S45).

The virtual store connection unit 212 determines whether or not a virtual store that is managed by the parent business of the actual store indicated by the store identification information in a combination selected in step S45 is included among the virtual stores that are affiliated with the shopping cart service in the product information management system 1 (step S46). If a virtual store that is managed by the parent business of the actual store is not included (step S46: NO), then the virtual store connection unit 212 generates link information directed to an arbitrary virtual store that carries the product indicated by the product identification information in the combination selected in step S45 (step S47). In contrast, if a virtual store that is managed by the parent business of the actual store is included (step S46: YES), then the virtual store connection unit 212 generates link information directed to a product purchase page, in said virtual store, showing product identification information for the combination selected in step S45 (step S48). As a result thereof, the product info′ nation management server 12 can make it easy to purchase a product in a virtual store that is managed by the same parent business as the actual store, thereby suppressing decreases in sales by the parent business due to showrooming.

When the virtual store connection unit 212 has generated link information for each combination read out in step S44, the cart information presentation unit 211 generates display information including each combination read out in step S44 and the link information generated by the virtual store connection unit 212, and transmits the information to the user terminal 15 (step S49). The user terminal 15, upon receiving the display information from the product information management server 12, displays the display information on the display. As a result thereof, the user can view, through the user terminal 15, a list of products that were approached in an actual store but were not purchased. Additionally, the display information displayed by the user terminal 15 includes link information to purchase pages for the products in virtual stores, so the user can easily purchase the products.

Thus, the product information management server 12 according to the present exemplary embodiment includes a product specifying unit 205 that specifies a product that was approached by a user in an actual store, and a recording unit 206 that records, in a cart table in a database apparatus 11 that can be viewed by the user, info′ nation associating the user with the product specified by the product specifying unit 205. In other words, the recording unit 206 records, in the database apparatus 11, information associating the user with the product specified by the product specifying unit 205, so as to be able to be viewed by the user. As a result thereof, by viewing information recorded in the cart table through the product information management server 12, the user can be prevented from forgetting a product that was approached in an actual store.

Additionally, the product information management server 12 according to the present exemplary embodiment further includes a purchase determination unit 208 that determines whether or not a user has purchased a product in an actual store, and the recording unit 206 records, in the cart table, the product and the user, in association with each other, in a manner distinguishing whether or not the product was purchased. Due to these features, the product information management server 12 can present to the user only products that have not been purchased. As a result thereof, the product information management server 12 can prevent cases in which unpurchased products are displayed together with products that have already been purchased. Additionally, because the product information management server 12 has the above-described features, a manager of an actual store can analyze what kind of products are more easily sold in actual stores by referring to the information stored in the cart table.

Additionally, the recording unit 206 of the product information management server 12 according to the present exemplary embodiment records, in a cart table, a product, a user and an actual store, in association with each other. Due to this feature, when presenting, to a user, products that were approached by the user but were not purchased, the product information management server 12 can include link information to a virtual store for the same parent business as the actual store in which the product was exhibited. As a result, the product information management server 12 can make it easy to purchase a product in a virtual store that is managed by the same parent business as the actual store, thereby suppressing decreases in sales by the parent business due to showrooming.

Additionally, according to the product information management server 12 of the present exemplary embodiment, when a product is settled in another store, the notification unit 209 notifies the store in which the user encountered the product of the settlement result. Due to this feature, the product information management server 12 makes it possible for the actual store to request an affiliate fee from the other store. As a result thereof, the product information management server 12 can suppress decreases in the sales of the actual store due to showrooming.

Additionally, the product specifying unit 205 of the product information management server 12 according to the present exemplary embodiment specifies that a product is a product that was approached by the user if the distance between the user and the product becomes equal to or less than a predetermined distance. Specifically, the product specifying unit 205 specifies a product as being a product that was approached by the user if the distance between the coordinates of an area specified by a facial recognition process and the coordinates of an area obtained by pattern matching a package image becomes a predetermined distance threshold value or less. As a result thereof, the product information management server 12 is able to appropriately specify products approached by the user.

Additionally, the product specifying unit 205 of the product information management server 12 according to the present exemplary embodiment specifies a product that was approached by the user if the user characteristic information and the product characteristic information are contained in sensor information obtained at the same time from a sensing device provided in the actual store. Specifically, the product specifying unit 205 specifies a product as being a product that was approached by a user if an area specified by a facial recognition process and an area obtained by pattern matching package images are included in the same frame image captured by the imaging apparatus 14. As a result thereof, the product information management server 12 can appropriately specify a product that was approached by a user.

### Second Exemplary Embodiment

The second exemplary embodiment will be explained.

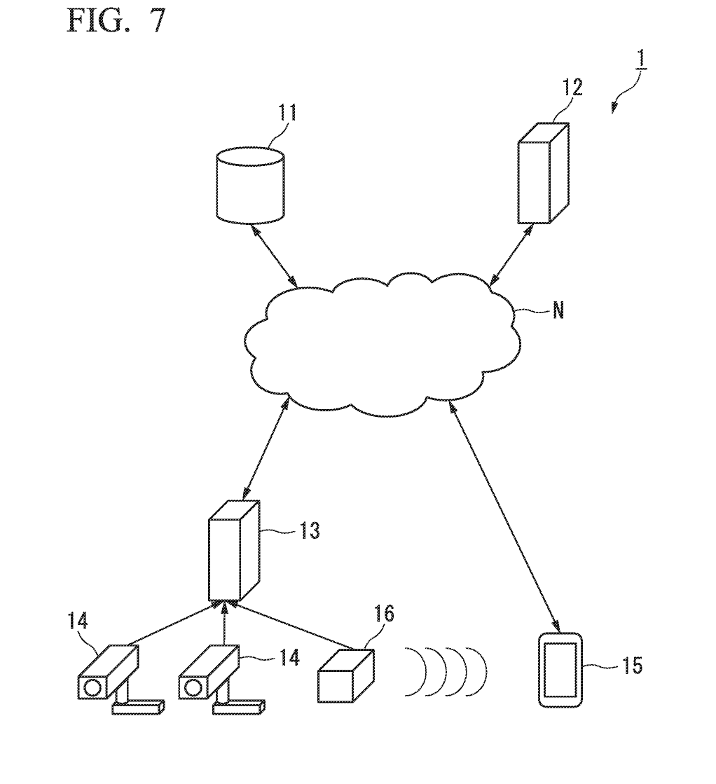

FIG. 7 is a schematic diagram showing the structure of a product information management system according to the second exemplary embodiment.

The product information management system 1 according to the first exemplary embodiment records, in the cart table, users and products in association with each other, by using facial characteristic amounts that are pre-recorded in the user table. In contrast thereto, the product information management system 1 according to the second exemplary embodiment is able to record users and products in association with each other, in the cart table, even if user characteristic information such as facial characteristics amounts are not pre-recorded in the user table. In other words, the user table in the database apparatus 11 according to the second exemplary embodiment does not need to store user characteristic information such as facial characteristic amounts of the users.

The product information management system 1 according to the second exemplary embodiment further includes, in addition to the features in the first exemplary embodiment, a wireless beacon 16. The wireless beacon 16 is provided at the entrance or exit of an actual store provided with a store server 13, and emits a predetermined signal by short-range wireless communication. Said signal includes information for identifying the actual store. If an application program for the shopping cart service is already installed, the user terminal 15, upon receiving the signal emitted by the wireless beacon 16, notifies the product information management server 12 that the signal has been received. Said notification includes user identification information registered in the application program. As a result thereof, the product information management server 12 is able to recognize that the user is visiting the actual store.

Additionally, at least one imaging apparatus 14 provided in each actual store captures images within the signal coverage of the wireless beacon 16. As a result thereof, the imaging apparatus 14 is able to capture images of the user possessing the user terminal 15 that received the signal from the wireless beacon 16.

Next, the features of the product information management server 12 according to the second exemplary embodiment will be explained.

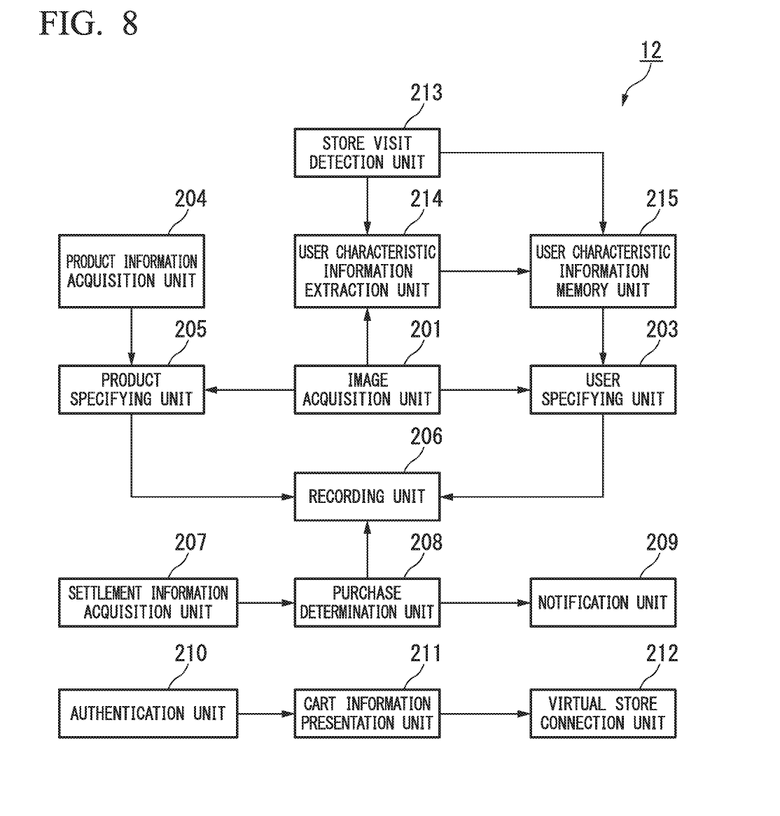

FIG. 8 is a schematic block diagram showing the structure of a product information management server according to the second exemplary embodiment.

The product information management server 12 according to the second exemplary embodiment includes, instead of the user information acquisition unit 202 in the first exemplary embodiment, a store visit detection unit 213, a user characteristic information extraction unit 214, and a user characteristic information memory unit 215.

The store visit detection unit 213 detects that a user is visiting the actual store by receiving a notification from the user terminal 15 to the effect that the signal emitted by the wireless beacon 16 has been received.

The user characteristic information extraction unit 214 analyzes an image that was captured by the imaging apparatus 14 at the time of reception of the signal emitted by the wireless beacon 16, and extracts a combination of colors of clothing worn by the user possessing the user terminal 15 that received the signal. The clothing color combination is an example of user characteristic information for specifying the user. It is to be noted that although the clothing color combination is extracted as the user characteristic information in the present exemplary embodiment, the present exemplary embodiment is not limited thereto. For example, in another exemplary embodiment, it is possible to extract facial images, facial characteristic amounts, action characteristic amounts (ambulatory patterns or the like), or other user characteristic information.

The user characteristic information memory unit 215 stores, in association with each other, user identification information and the clothing color combination extracted by the user characteristic information extraction unit 214.

Next, the operations that are performed when the product information management server 12 according to the present exemplary embodiment extracts user identification information will be explained.

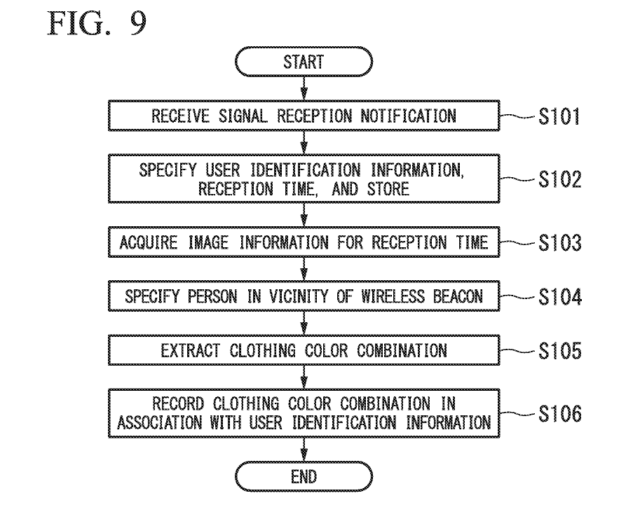

FIG. 9 is a flow chart showing user identification information extraction operations performed by the product information management server according to the second exemplary embodiment.

When the user terminal 15 receives the signal emitted by the wireless beacon 16, the user terminal 15 notifies the product information management server 12 that the signal has been received. Said notification includes information for identifying the actual store, the signal reception time, and user identification information. The store visit detection unit 213 of the product information management server 12 receives the notification that the signal has been received from the user terminal 15 (step S101). From the information included in the notification, the store visit detection unit 213 specifies the actual store that emitted the signal, the signal reception time, and the user identification information (step S102).

Next, the user characteristic information extraction unit 214 acquires, from the image acquisition unit 201, image information captured at the specified reception time by an imaging apparatus 14, among those installed in the actual store specified by the store visit detection unit 213, that captures images of the vicinity of the wireless beacon 16 (step S103). Next, the user characteristic information extraction unit 214 specifies, from among images indicated by the acquired image information, the person that is closest to the wireless beacon 16 (step S104). The user characteristic information extraction unit 214, for example, extracts facial areas from the images indicated by the image information, and specifies, among the extracted facial areas, the extracted facial area that is closest to the coordinates of the wireless beacon 16 as being the face of the person closest to the wireless beacon 16.

Next, the user characteristic information extraction unit 214 extracts the clothing color combination of the specified person (step S105). Next, the user characteristic information extraction unit 214 records the specified combination and the identification information specified in step S102, in association with each other, in the user characteristic information memory unit 215 (step S106).

Then, the product information management server 12, when writing a record in the cart table, specifies a user and a product that was approached by the user, by utilizing the clothing color combination stored by the user characteristic information memory unit 215. The process whereby the product information management server 12 writes a record in the cart table can be implemented by means of a process similar to that of the first exemplary embodiment, with the exception that the clothing color combination stored by the user characteristic information memory unit 215 is used.

Thus, according to the present exemplary embodiment, the product information management server 12 further includes a store visit detection unit 213 that detects a visit of a user to an actual store on the basis of a user terminal 15 possessed by the user, and a user characteristic information extraction unit 214 that extracts a clothing color combination by means of an imaging apparatus 14 provided at the location where the user is present when the store visit detection unit 213 specifies the user. The store visit detection unit 213 specifies a product that was approached by the user on the basis of the clothing color combination. As a result thereof, the product information management server 12 is able to record, in the cart table, a user and a product that was approached by the user, in association with each other, even if user characteristic information is not pre-stored in the user table.

It is to be noted that in the present exemplary embodiment, the store visit detection unit 213 detects a store visit by a user on the basis of a notification of reception of a signal from the user terminal 15, but the present exemplary embodiment is not limited thereto. For example, in a store visit detection unit 213 according to another exemplary embodiment, a user terminal 15 could transmit user identification information to a receiver provided in an actual store, and a store visit by a user could be detected on the basis of a signal reception notification from the receiver. Additionally, in another exemplary embodiment, when an actual store is provided with a possession authentication apparatus such as a point card recognition apparatus or a biological authentication apparatus such as a fingerprint authentication apparatus, the store visit detection unit 213 may detect a store visit on the basis of authentication results from such an apparatus.

### Third Exemplary Embodiment

The third exemplary embodiment will be explained.

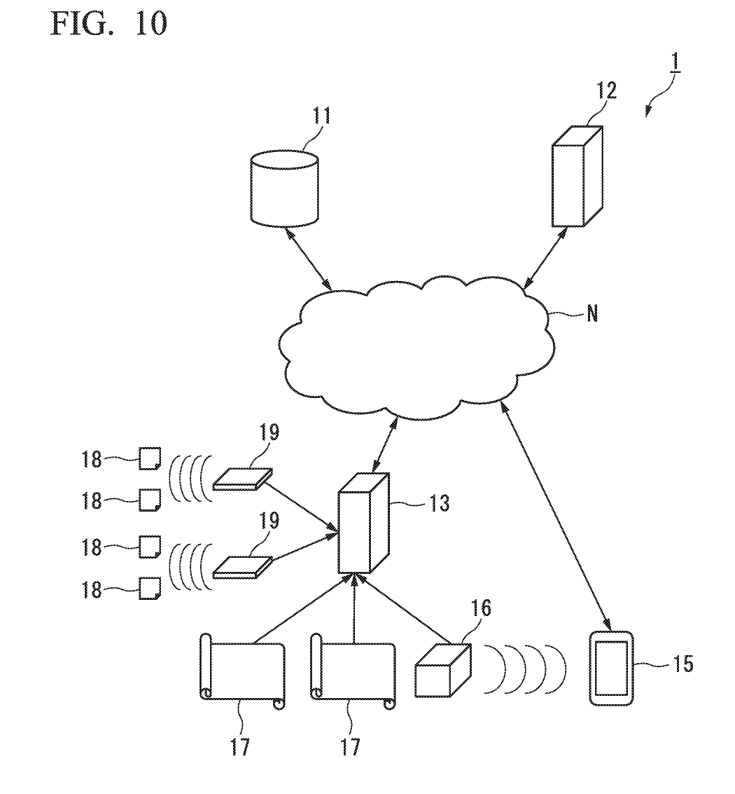

FIG. 10 is a schematic diagram showing the structure of a product information management system according to the third exemplary embodiment.

The product information management systems 1 according to the first exemplary embodiment and the second exemplary embodiment recognize the user and the product by using an imaging apparatus 14 as the sensing device. On the other hand, personal recognition by means of facial authentication is sometimes avoided in order to protect privacy. Therefore, the product information management system 1 according to the third exemplary embodiment records, in a cart table, users and products in association with each other, by using a sensing device that is different from an imaging apparatus 14. As a result thereof, the product information management system 1 can make users recognize products that were approached in an actual store while reducing the psychological resistance of the users.

The product information management system 1 according to the third exemplary embodiment includes sensor sheets 17, RFID (Radio Frequency Identifier) tags 18, and RFID readers 19 instead of the imaging apparatuses 14 in the structure according to the second exemplary embodiment.

The sensor sheet 17 emits weak radio waves from the surface thereof and detects disturbances in the radio waves to recognize the shapes of footprints of people present on the sensor sheet 17. The sensor sheet 17 is capable of recognizing multiple footprint shapes. The sensor sheet 17 is laid on the floor within the signal coverage of the wireless beacon 16, and on the sales floor of each actual store that is affiliated with the shopping cart service.

RFID tags 18 are passive tags that are applied to the products displayed on the sales floor, such that the reflected waves from signals emitted by the RFID reader 19 include information for identifying the products. Said information is an example of product characteristic information.

The RFID reader 19 is provided on a shelf on which products are displayed, emits radio waves towards the RFID tags 18 applied to the products, and reads the information for identifying the products from the reflections of the radio waves.

The sensor sheet 17 and the RFID reader 19 are examples of sensing devices provided in an actual store.

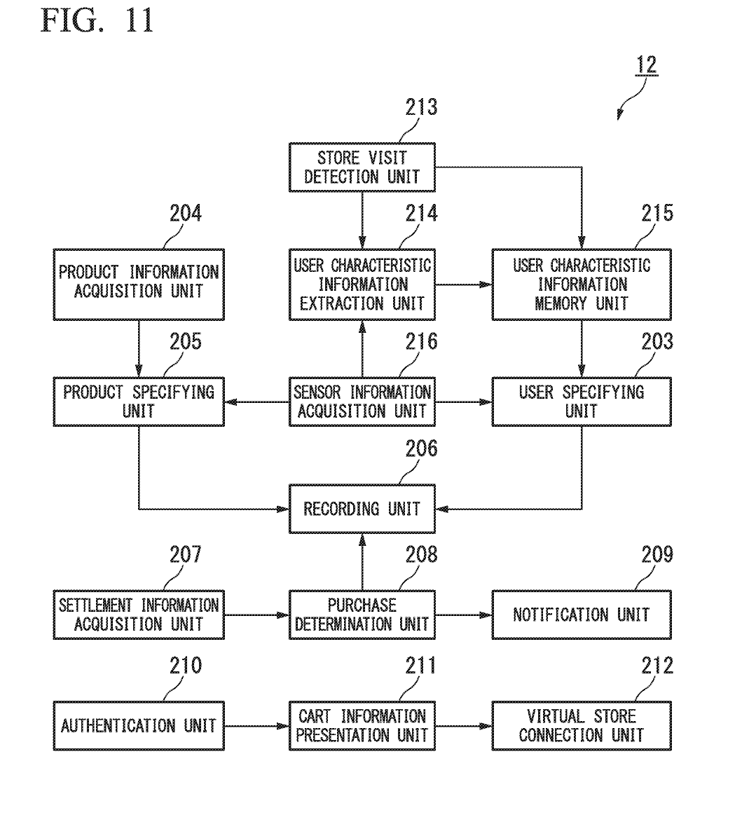

FIG. 11 is a schematic block diagram showing the structure of the product information management server according to the third exemplary embodiment.

The product information management server according to the third exemplary embodiment includes a sensor information acquisition unit 216 instead of the image acquisition unit 201 in the second exemplary embodiment. The sensor information acquisition unit 216 acquires, from the sensor sheet 17, information regarding the shapes of footprints and the coordinates at which the footprints lie. Additionally, the sensor information acquisition unit 216 acquires, from the RFID reader 19, information for identifying products displayed on shelves.

The operations of the product information management server according to the present exemplary embodiment will be explained.

First, user identification information extraction operations performed by the product information management server 12 will be explained.

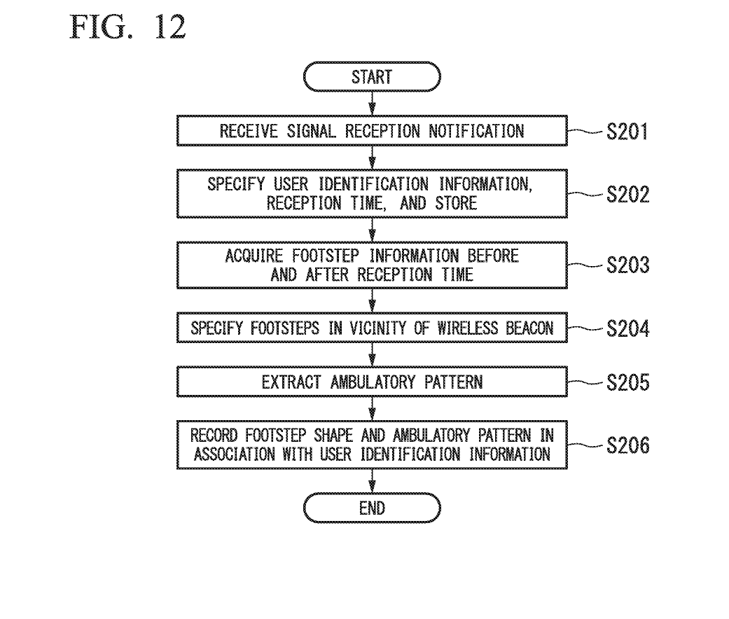

FIG. 12 is a flow chart showing the user identification information extraction operations performed by the product information management server according to the third exemplary embodiment.

When the user terminal 15 receives a signal emitted by a wireless beacon 16, the user terminal 15 notifies the product information management server 12 that a signal has been received. Said notification includes information for identifying the actual store, the signal reception time, and user identification information. The store visit detection unit 213 of the product information management server 12 receives the notification that the signal has been received from the user terminal 15 (step S201). From the information included in the notification, the store visit detection unit 213 specifies the actual store that emitted the signal, the signal reception time, and the user identification information (step S202).

Next, the user characteristic information extraction unit 214 acquires, form the sensor information acquisition unit 216, footprint information (footprint shapes and footprint coordinates) detected, during a predetermined period of time before and after—(e.g., 10 seconds before and after) the specified reception time, by a sensor sheet 17 that lies in the vicinity of the wireless beacon 16, among those installed in the actual store specified by the store visit detection unit 213 (step S203). Next, the user characteristic information extraction unit 214 specifies, from among the acquired footprint information, the footprint lying closest to the wireless beacon 16 (step S204).

Next, the user characteristic information extraction unit 214 specifies a trail left by footprints specified within a predetermined period of time, and extracts an ambulatory pattern of a user specified by the footprints on the basis of said trail (step S205). Next, the user characteristic information extraction unit 214 records the footprint shape and extracted ambulatory pattern and the user identification information specified in step S202, in association with each other, in the user characteristic information memory unit 215 (step S206).

As a result, the product information management server 12 is able to record the footprint shape and ambulatory pattern as user characteristic information in the user characteristic memory unit 215. It is to be noted that while the product information management system 1 according to the present exemplary embodiment uses footprint shapes and ambulatory patterns as user characteristic information, the present exemplary embodiment is not limited thereto. For example, a product information management system 1 according to another exemplary embodiment may use either footprint shapes or ambulatory patterns as the user characteristic information.

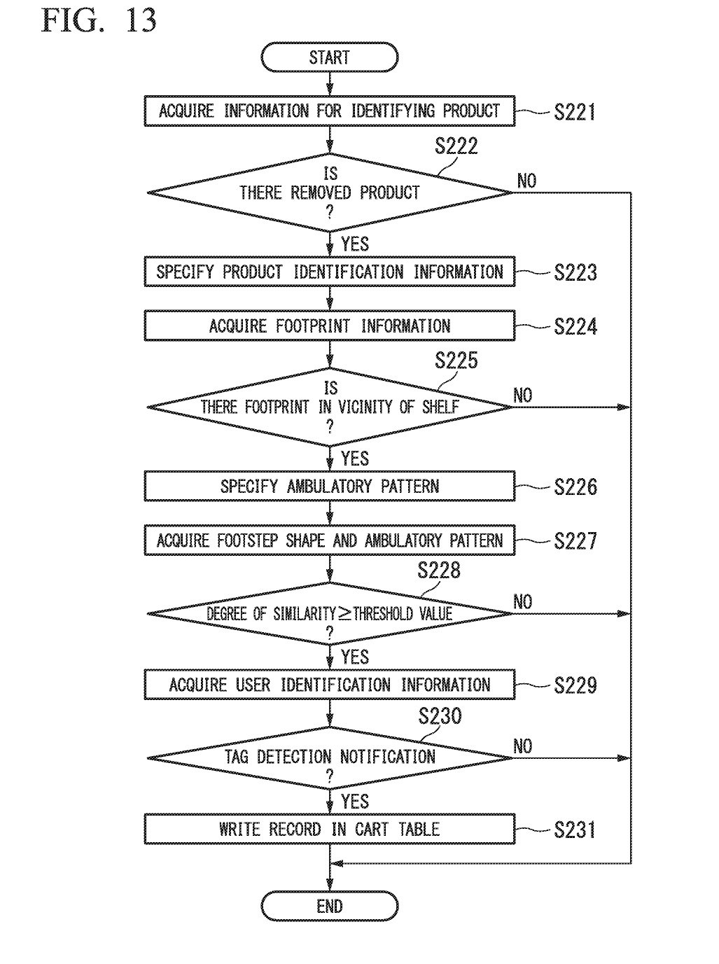

FIG. 13 is a flow chart showing product registration operations by the product information management server according to the third exemplary embodiment.

The sensor information acquisition unit 216 in the product information management server 12 acquires, from the RFID reader 19, information for identifying products that the RFID reader 19 has read from the RFID tags 18 (step S221). The product specifying unit 205 compares the information that the sensor information acquisition unit 216 has currently acquired with information previously acquired by the sensor information acquisition unit 216, to determine whether or not a product has been removed from the shelf (step S222). If no products have been removed from the shelf (step S222: NO), it is inferred that there are no products that were approached by the user, so the product information management server 12 ends the process.

In contrast, if there is a product that has been removed from the shelf (step S222: YES), the product specifying unit 205 specifies product identification information for the removed product (step S223). Next, the sensor information acquisition unit 216 acquires, from the sensor sheet 17, footprint information detected during the predetermined time period before and after the relevant time (step S224). Next, the user specifying unit 203 determines, on the basis of the acquired footprint information, whether or not there are any footprints in the vicinity (e.g., within 2 meters) of the shelf on which the product specified in step S223 was displayed (step S225). If there are no footprints in the vicinity of the shelf on which the product was displayed (step S225: NO), it can be inferred that the product was removed from the shelf due to an event unrelated to the approach of a user, such as the product having fallen, so the product information management server 12 ends the process.

In contrast, if there are footprints in the vicinity of the shelf on which the product was displayed (step S225: YES), the user specifying unit 203 specifies a trail left by the footprints during a predetermined period of time, and extracts an ambulatory pattern specified by the footprints on the basis of the trail (step S226). Next, the user specifying unit 203 reads the footprint shapes and ambulatory patterns of all users from the user characteristic information memory unit 215 (step S227). Next, the user specifying unit 203 determines whether or not the degree of similarity between the footprint shape and ambulatory pattern relating to the specified footprint and a footprint shape and ambulatory pattern acquired from the user characteristic information memory unit 215 is equal to or greater than a predetermined threshold value (step S228). If the degrees of similarity of the footprint shapes and ambulatory patterns are less than the predetermined threshold value (step S228: NO), then the product information management server 12 ends the process.

If the degrees of similarity of the footprint shapes and ambulatory patterns are equal to or greater than the predetermined threshold value for the degree of similarity (step S228: YES), the user specifying unit 203 acquires, from the user characteristic information memory unit 215, user identification information associated with said footprint shape and ambulatory pattern (step S229). As a result thereof, the user specifying unit 203 specifies a user detected by the sensor sheet 17. As a result thereof, the product specifying unit 205 specifies the product specified in step S223 as being a product that was approached by the user.

In other words, the product specifying unit 205 specifies a product that was approached by the user on the basis of information for identifying the product, and information, among the information obtained from the RFID reader 19, that was obtained at the time of acquisition of the ambulatory information used by the user specifying unit 203 to specify the user.

Next, the product specifying unit 205 determines whether or not information regarding a removed product has been detected again on the basis of the information from the RFID tag 18 acquired by the sensor information acquisition unit 216 (step S230). As a result thereof, the product specifying unit 205 determines whether or not the product has been returned to the display shelf. If the product is not returned to the display shelf (step S230: NO), the process is ended without recording the user and the product in the cart table in the database apparatus 11.

In contrast, if the product is returned to the display shelf (step S230: YES), the recording unit 206 writes, in the cart table in the database apparatus 11, a record associating the user identification information specified by the user specifying unit 203, the product identification information specified by the product specifying unit 205, and the store identification information of the actual store provided with the store server 13 that transmitted the image information (step S231). Due to the above processes, the product information management server 12 can register, in the virtual cart, a user, a product that was approached by the user, and the actual store exhibiting said product, in association with each other.

Thus, according to the present exemplary embodiment, the product information management system 1 can record, in the database apparatus 11, a user and a product that was approached by the user in association with each other, without using the imaging apparatus 14. As a result thereof, the product information management system 1 can make users recognize products that were approached in an actual store while reducing the psychological resistance of the users.

It is to be noted that while the present exemplary embodiment includes modifications to part of the structure of the second exemplary embodiment, the present exemplary embodiment is not limited thereto. In another exemplary embodiment, part of the structure of the first exemplary embodiment may be modified so that the product information management system 1 achieves effects similar to those of the present exemplary embodiment. In that case, the user table in the database apparatus 11 must pre-store the footprint shape or ambulatory pattern of the user.

### Fourth Exemplary Embodiment

The product information management system 1 according to the fourth exemplary embodiment associates a level of interest of the user with a product that was approached by the user.

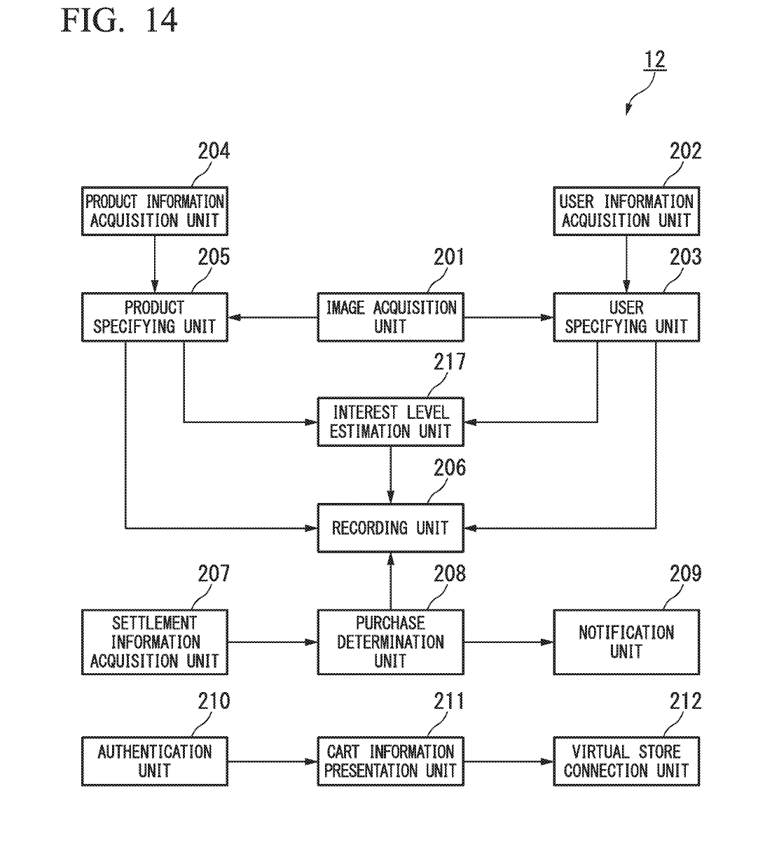

FIG. 14 is a schematic block diagram showing the structure of a product information management server according to the fourth exemplary embodiment.

The product information management server 12 according to the fourth exemplary embodiment further includes, in addition to the features in the first exemplary embodiment, an interest level estimation unit 217. Additionally, in the product information management server 12 according to the fourth exemplary embodiment, the operations of the recording unit 206 and the cart information presentation unit 211 differ from those in the first exemplary embodiment.

The interest level estimation unit 217 estimates the level of interest of a user in a product that was approached by the user. The interest level estimation unit 217 may, for example, estimate the level of interest based on the length of time during which the distance between the user specified by the user specifying unit 203 and the product specified by the product specifying unit 205 was less than a predetermined distance threshold value. Additionally, for example, the interest level estimation unit 217 may estimate the level of interest based on the number of times that the user specified by the user specifying unit 203 looked at the product specified by the product specifying unit 205. Additionally, for example, the interest level estimation unit 217 may estimate the level of interest based on the number of matches with package images (front surface, side surface, rear surface, bottom surface, top surface, etc.) stored in the product table while the distance between the user specified by the user specifying unit 203 and the product specified by the product specifying unit 205 is less than a predetermined distance threshold value.

The recording unit 206 records, in the cart table, the product identification information specified by the product specifying unit 205, the user identification information specified by the user specifying unit 203, the store identification information of the actual store in which the product was displayed, and the interest level estimated by the interest level estimation unit 217, in association with each other.

The cart information presentation 211 generates display information in which combinations of products and actual stores read from the cart table are arranged in the order of higher interest levels, and transmits the information to the user terminal 15.

Due to the above-described structure, the user can view, in the user terminal 15, a list of products that were approached in actual stores but were not purchased, arranged in the order of higher interest levels. As a result thereof, the user can easily be made to recognize products for which the interest level is high among multiple products that were approached.

It is to be noted that while the present exemplary embodiment includes modifications to part of the structure of the first exemplary embodiment, the present exemplary embodiment is not limited thereto. In other exemplary embodiments, part of the structure of the second or third exemplary embodiment may be modified so that the product information management system 1 achieves effects similar to those of the present exemplary embodiment. In an exemplary embodiment in which the interest level estimation unit 217 is added to the structure of the third exemplary embodiment, the interest level estimation unit 217 may, for example, estimate the level of interest based on the time during which the footsteps paused in front of the shelf on which a product is displayed. Additionally, for example, the interest level estimation unit 217 may estimate the level of interest based on the time during which the product identification information was not able to be acquired from the RFID tag 18.

### Other Exemplary Embodiments

While exemplary embodiments have been explained in detail with reference to the drawings above, the specific structure is not limited to those mentioned above, and various design modifications and the like are possible.

The product information management server 12 according to the above-described exemplary embodiments records, in the database apparatus 11, products and users in association with each other, in a manner distinguishing whether or not the products have been purchased, by deleting purchased products from the cart table, but the present exemplary embodiment is not limited thereto. For example, in another exemplary embodiment, the product information management server 12 may record, in the database apparatus 11, products and users in association with each other, in a manner distinguishing whether or not the products have been purchased by recording, in the cart table, information indicating whether or not a product has already been purchased. Additionally, in another exemplary embodiment, products and users may be recorded in association with each other, in the database apparatus 11, in a manner distinguishing whether or not the products have been purchased by providing a column, in the cart table, that records store identification information for stores in which products were purchased. Specifically, the product information management server 12 records a null value or a dummy value in the column as long as a product has not been purchased, and records store identification information in the column when the product is purchased. As a result thereof, it is possible to distinguish whether or not a product has been purchased based on whether store identification information is stored in the column or a null value or dummy value is stored therein. Additionally, in another exemplary embodiment, the product information management server 12 may record information in a different table depending on whether or not a product has been purchased.

The product information management servers 12 according to the first and second exemplary embodiments specify products that are within a predetermined distance from a face appearing in an image indicated by image information as products that were approached. Additionally, the product information management server 12 according to the third exemplary embodiment specifies products that have been approached by a user based on the presence or absence of a signal emitted by an RFID tag 18. On the other hand, the method for specifying products approached by a user is not limited thereto. For example, the product information management server 12 according to another exemplary embodiment may detect the line of sight of a user from an image indicated by image information, and specify a product that has been in the line of sight for a predetermined period of time as a product that was approached by the user. Additionally, in another exemplary embodiment, a mass gauge may be provided on a shelf on which a product is displayed, and a product that has been approached by the user may be specified on the basis of changes in mass detected by the mass gauge.

Additionally, in the above-described exemplary embodiments, when a user does not return a product to a shelf, the product information management server 12 does not record the product identification information of said product and the user identification information of said user in the cart table, but the exemplary embodiments are not limited thereto. For example, the product information management server 12 could be configured so as not to record the product identification information of a product and the user identification information of a user in the cart table when the user places a product inside a basket. Additionally, since the recording unit 206 will delete a product from the cart table when the purchase determination unit 208 determines that the product has been purchased, the product identification information and the user identification information could be recorded in the cart table regardless of whether or not the product has been returned to the shelf or whether or not the product has been placed in a basket.

Additionally, the product information management servers 12 according to the above-described first, second, and fourth exemplary embodiments determine that a user has approached a product when a package image of the product has been matched by pattern matching, but the exemplary embodiments are not limited thereto. For example, a product information management server 12 according to another exemplary embodiment may determine that a user has approached a product when a predetermined surface (for example, a surface on which an explanation is written) among the package images of the product is matched by pattern matching, or when the price tag of the product is matched by pattern matching.

Additionally, in the above-described exemplary embodiments, the product information management server 12 determines that a user has approached a product when the user actually approaches the product, but the exemplary embodiments are not limited thereto. For example, the product information management server 12 according to another exemplary embodiment may determine that a user has approached a product when a catalog for a predetermined product provided in an actual store is viewed. Additionally, for example, the product information management server 12 according to another exemplary embodiment may determine that a user has approached a product when information on a certain product has been viewed on a terminal provided in an actual store.

Additionally, in the above-described exemplary embodiments, the product information management server 12 presents a user terminal 15 with product information registered in a virtual cart, but the exemplary embodiments are not limited thereto. For example, the product information management server 12 according to another exemplary embodiment may present, to the user terminal 15, the price, at a virtual store, of a product that is registered in the virtual cart, before the product is settled. As a result thereof, the user can, before purchasing a product, give consideration at to the store in which the product should be purchased. At this time, the product information management server 12 may notify the store server 13 of the virtual store that the user is considering purchasing the product, and have a discounted price inputted for the product. Additionally, when the user purchases the product in a virtual store, the product information management server 12 may notify the actual store of the price of the product in the virtual store. As a result thereof, the owner of the actual store may analyze the level of the price difference with a virtual store for which products will be purchased at the actual store.

Additionally, in the above-described exemplary embodiments, the product information management server 12 determines products that were approached by users, registers users and products, and presents products to users, but the exemplary embodiments are not limited thereto. In other words, in another exemplary embodiment, the product information management apparatus may be installed in another apparatus. For example, in another exemplary embodiment, the store server 13 may be equipped with the product information management apparatus. In other words, the processing units in the product information management server 12 may be provided in each store server 13.

Additionally, in another exemplary embodiment, the user terminal 15 may be equipped with the product information management apparatus. In this case, the user terminal 15 may specify a product that appears in an image captured by the apparatus itself or in an image captured by a wearable device worn by the user as being a product that was approached by the user. Additionally, in this case, a memory area corresponding to the database apparatus 11 must be secured within an auxiliary memory apparatus in the user terminal 15. In that case, the user terminal 15 may implement the functions of a product information management apparatus in stand-alone fashion.

Additionally, in another exemplary embodiment, some of the processing by the product information management server 12 may be executed by another apparatus. For example, some of the processes such as facial recognition processes by the user specifying unit 203, pattern matching of package images by the product specifying unit 205, and presentation of the virtual cart to the user terminal 15 may be executed by other apparatus, and the product information management server 12 may acquire the results of execution thereof. In this case, the user specifying unit 203 may specify a user by acquiring the results of a facial recognition process from another apparatus. Additionally, the product specifying unit 205 may specify a product by acquiring the results of pattern matching from another apparatus.

Additionally, the product information management systems 1 according to the above-described exemplary embodiments record, in the database apparatus 11, information associating users and products which are goods that are to be sold, but the exemplary embodiments are not limited thereto. For example, the product information management system 1 according to another exemplary embodiment may associate users with products which are services that are to be sold. Specifically, the product information management system 1 according to another exemplary embodiment may associate users with services when the users approach the locations at which the services are provided (for example, lodgings, aesthetic salons, or the like). Additionally, the product information management system 1 according to another exemplary embodiment, in the case of rental services, may associate users with rental items that have been approached by users (for example, books, CDs (Compact Discs), automobiles, or real estate).

Additionally, for example, the product information management system 1 according to another exemplary embodiment may record, in the database apparatus 11, related information relating to the information associating products and users. In other words, the memory unit 206 according to another exemplary embodiment may generate related information relating to the information associating products and users, and record the related information in the database apparatus 11. For example, the product information management system 1 according to another exemplary embodiment may record, as related information in a database apparatus 11, information associating users with other products related to products approached by the users (for example, products similar to said products or products that are likely to be purchased simultaneously with said products). Additionally, the product information management system 1 according to another exemplary embodiment may record, in the database apparatus 11, other information generated from the information associating products and users.

### <<Basic Structure>>

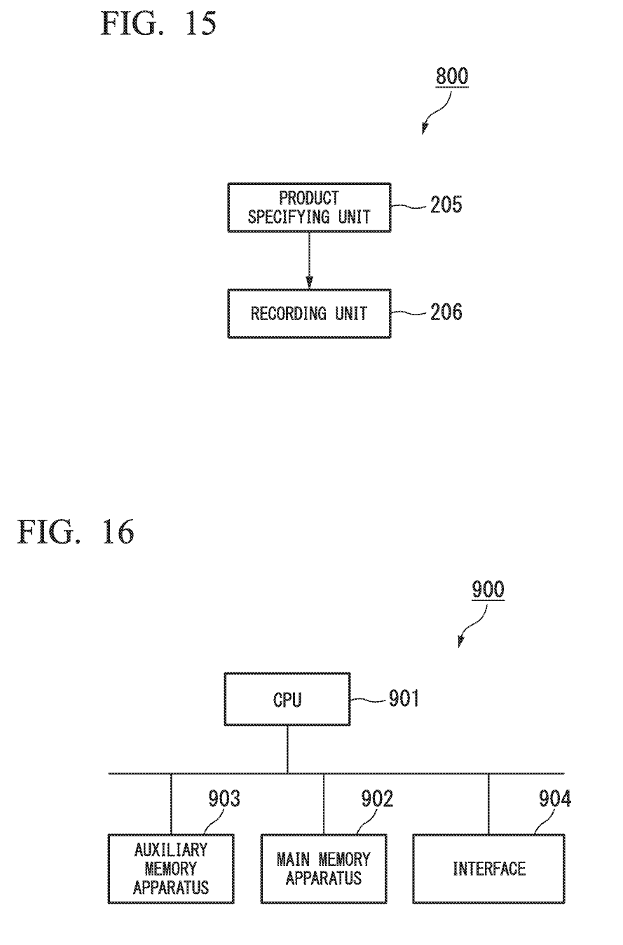

FIG. 15 is a schematic block diagram showing the basic structure of a product information management apparatus.

In the above-described exemplary embodiments, the structures shown in FIG. 3, FIG. 8, FIG. 11 and FIG. 14 were explained as exemplary embodiments of the product information management apparatus 800, but the basic structure of the product information management apparatus 800 is as shown in FIG. 15.

In other words, the product information management apparatus 800 has a product specifying unit 205 and a recording unit 206 as the basic structure. The product specifying unit 205 specifies a product that has been approached by a user in an actual store. The recording unit 206 associates the product specified by the product specifying unit 205 with the user, and records the information in a memory unit that can be viewed by the user.

As a result thereof, the product information management apparatus 800 can make the user recognize products that were approached in an actual store.

FIG. 16 is a schematic block diagram showing the structure of a computer according to at least one exemplary embodiment.

The computer 900 includes a CPU (Central Processing Unit) 901, a main memory apparatus 902, an auxiliary memory apparatus 903, and an interface 904.

The above-mentioned product information management server 12 (product information management apparatus) is installed in the computer 900. Additionally, the operations of the above-mentioned processing units are stored in the auxiliary memory apparatus 903 in the form of programs. The CPU 901 reads out programs from the auxiliary memory apparatus 903, deploys the programs in the main memory apparatus 902, and executes the above-described processes in accordance with the programs. Additionally, in accordance with the programs, the CPU 901 secures memory areas corresponding to above-mentioned user characteristic information memory unit 215 in the main memory apparatus 902 or the auxiliary memory apparatus 903.

It is to be noted that in at least one exemplary embodiment, the auxiliary memory apparatus 903 is an example of a non-transitory tangible medium. Other examples of non-temporary tangible media include magnetic disks, magneto-optic disks, CD-ROMs (Read Only Memory), DVD (Digital Versatile Disc)-ROMs, semiconductor memory and the like, connected via the interface 904. Additionally, when the programs are delivered to the computer 900 via communication lines, the computer 900 which has received the delivery may deploy the programs in the main memory apparatus 902, so as to execute the above-described processes.

Additionally, the programs may be for implementing the aforementioned functions in part. Furthermore, the programs may be so-called difference files (difference programs) that are combined with other programs already stored in the auxiliary memory apparatus 903 to implement the aforementioned functions.

The present application claims priority on the basis of Japanese Patent Application No. 2015-059496, filed Mar. 23, 2015, the entire disclosure of which is incorporated herein by reference.

### INDUSTRIAL APPLICABILITY

The present invention may, for example, be applied to various stores and user terminals. According to the present invention, a user can recognize products that were approached in actual stores by viewing the information stored in the memory unit. Therefore, the user can be prevented from forgetting about products that were approached in actual stores.

### DESCRIPTION OF REFERENCE SIGNS

1 product information management system
11 database apparatus
12 product information management server
13 store server
14 imaging apparatus
15 user terminal
203 user specifying unit
205 product specifying unit
206 memory unit
207 settlement information acquisition unit
208 purchase determination unit
209 notification unit
213 store visit detection unit
214 user characteristic information extraction unit
216 sensor information acquisition unit

1. A product information management apparatus comprising:
a product specifying unit that specifies a product that was approached by a user in an actual store;
an association unit that generates association information, which is information associating the product specified by the product specifying unit with the user or related information relating to the information associating the product with the user; and
a recording unit that records the association information in a memory unit so as to be able to be viewed by the user.

2. The product information management apparatus according to claim 1, further comprising an in-store purchase determination unit that determines whether or not the user purchased the product in the actual store,
wherein the recording unit records the association information in the memory unit in a manner distinguishing whether or not the product has been purchased.

3. The product information management apparatus according to claim 1, wherein the association unit generates, as the association information, information associating the product, the user, and the actual store, or related information relating to the information associating the product, the user, and the actual store.

4. The product information management apparatus according to claim 3, further comprising:
an out-of-store purchase determination unit that determines whether or not the product has been purchased, by the user associated with the product, in another store other than the actual store associated with the product; and
a notification unit that, if the out-of-store purchase determination unit determines that the product has been settled in the other store, notifies the actual store of a settlement result.

5. The product information management apparatus according to claim 1, wherein the product specifying unit specifies, as the product that was approached by the user, a product if the distance between the user and the product becomes equal to or less than a predetermined distance.

6. The product information management apparatus according to claim 1, further comprising a user specifying unit that specifies the user on the basis of sensor information obtained from a sensing device provided in the actual store and user characteristic information for specifying the user,
wherein the product specifying unit specifies the product that was approached by the user on the basis of sensor information that was obtained at the same time as the sensor information used to specify the user, among the sensor information obtained from the sensing device or from another sensing device provided in the actual store, and product characteristic information for specifying the product.

7. The product information management apparatus according to claim 6, further comprising:
a store visit detection unit that detects that the user is visiting the actual store on the basis of biological information of the user or a possession of the user; and
a user characteristic information extraction unit that extracts the user characteristic information by means of a sensing device provided in a location at which the user is present when the store visit detection unit specifies a store visit by the user,
wherein the product specifying unit specifies the product that was approached by the user on the basis of the user characteristic information.

8. The product information management apparatus according to claim 1, wherein the association unit generates, as the association information, information associating the product, the user, and a level of interest of the user in the product, or related information relating to the information associating the product, the user, and the level of interest.

9. A product information management system comprising:
the product information management apparatus according to claim 1; and
the memory unit that stores the association information.

10. A product information management method comprising:
a step of specifying a product that was approached by a user in an actual store;
a step of generating association information, which is information associating the specified product with the user or related information relating to the information associating the product with the user; and
a recording step of recording the association information in a memory unit so as to be able to be viewed by the user.

11. A non-transitory computer-readable medium storing a program for causing a computer to function as:
a product specifying unit that specifies a product that was approached by a user in an actual store;
an association unit that generates association information, which is information associating the product specified by the product specifying unit with the user or related information relating to the information associating the product with the user; and
a recording unit that records the association information in a memory unit so as to be able to be viewed by the user.
